(19) United States
(12) Patent Application Publication
(10) Pub. No.: US 2021/0247340 A1
(43) Pub. Date: Aug. 12, 2021

(54) Sensor Device for Determining the Electrical Conductivity of a Fluid and the Speed of Sound in the Fluid

(71) Applicant: Vitesco Technologies Germany GmbH, Hannover (DE)

(72) Inventors: Daniel Meyer, München (DE); Karl-Friedrich Pfeiffer, München (DE)

(73) Assignee: Vitesco Technologies Germany GmbH, Hannover (DE)

(21) Appl. No.: 17/049,628

(22) PCT Filed: Apr. 1, 2019
(86) PCT No.: PCT/EP2019/058162

§ 371 Date: Oct. 22, 2020

(30) Foreign Application Priority Data
Apr. 25, 2018 (DE) 10 2018 206 360.5

(51) Int. Cl. G01N 27/07; G01N 27/10

(52) U.S. Cl. CPC G01N 27/07; G01N 27/10

(57) ABSTRACT

Various embodiments include a sensor device for determining an electrical conductivity of a fluid and a speed of sound in the fluid comprising: a first electrode; a second electrode electrically isolated from the first electrode; and a sound transducer to emit sound waves into the fluid toward the first electrode and/or the second electrode, and to receive sound waves reflected back by the respective electrode to determine the speed of sound in the fluid. Each electrode is in direct contact with the fluid and is operable to determine the electrical conductivity of the fluid using the conductive principle.

### CROSS-REFERENCE TO RELATED APPLICATIONS

This application is a U.S. National Stage Application of International Application No. PCT/EP2019/058162 filed Apr. 1, 2019, which designates the United States of America, and claims priority to DE Application No. 10 2018 206 360.5 filed Apr. 25, 2018, the contents of which are hereby incorporated by reference in their entirety.

### TECHNICAL FIELD

The present disclosure relates to sensors. Various embodiments include sensor devices for determining the electrical conductivity of a fluid and the speed of sound in the fluid, in particular in fluids for internal combustion engines, such as for example water for water injection.

### BACKGROUND

Conductive conductivity sensors are used in a variety of applications to measure the conductivity of a medium. The best-known conductive conductivity sensors are what are known as two-electrode or four-electrode sensors. Two-electrode sensors have two electrodes that are immersed in the medium during measurement operation and to which a DC or AC voltage is applied. Measuring electronics connected to the two electrodes measure an electrical impedance of the conductivity measurement cell, from which a specific resistance or a specific conductance of the medium located in the measurement cell is then ascertained on the basis of a cell constant defined in advance by the geometry and nature of the measurement cell.

Four-electrode sensors have four electrodes immersed in the medium during measurement operation, two of which are operated as what are known as current electrodes and two of which are operated as what are known as voltage electrodes. During measurement operation, a DC or AC voltage is applied between the two current electrodes, and a DC or AC current is thus fed into the medium. The current that is fed in causes a potential difference between the voltage electrodes, which is determined through a preferably current-free measurement. In this case too, the impedance of the conductivity measurement cell, resulting from the fed-in current and the measured potential difference, is determined by way of measurement electronics connected to the current and voltage electrodes, from which a specific resistance or a specific conductance of the medium located in the measurement cell is then determined on the basis of a cell constant defined in advance by the geometry and the nature of the measurement cell.

EP 1 089 072 A2 describes a conductivity sensor that has a circular-cylindrical housing, wherein metal measurement electrodes are arranged in a planar manner on a circular-surface-shaped end wall of the circular-cylindrical housing. The metal measurement electrodes in this case form two voltage electrodes and two current electrodes. The voltage electrodes are designed in the shape of a circular surface and are surrounded by the two circular or circular-surface-shaped current electrodes arranged essentially in a semicircle. Further conductivity sensors are described in U.S. Pat. No. 4,227,151 A, EP 0 386 660 A1, and DE 10 2010 042 637 A1.

(Ultra)sound-based sensors are furthermore used to determine the speed of sound of a sound signal in a fluid in a fluid container, which sensors have a sound transducer both as sound generator and as sound receiver. In order to determine the speed of sound of the sound signal in the fluid, sound pulses may be emitted into the fluid to be measured by way of the sound transducer. Conclusions about the speed of sound of the sound signal in the fluid may be drawn from the time of flight of the sound pulses. For this purpose, a reference reflector is arranged at a predetermined distance from the sound transducer. By way of example, a device for determining the speed of sound of a sound signal in a fluid is described in DE 10 2014 213 233 A1.

### SUMMARY

The present disclosure describes sensor devices able to record both the electrical conductivity of a fluid and the speed of sound in the fluid in a simple and inexpensive manner. As an example, some embodiments of the teachings herein include a sensor device (100) for determining the electrical conductivity of a fluid (12) and the speed of sound in the fluid (12), wherein the sensor device (100) has: at least one pair of electrodes (110), which has a first electrode (112) and a second electrode (114) electrically isolated from the first electrode (112), each of which is in direct contact with the fluid (12), and is designed to determine the electrical conductivity of the fluid (12) in accordance with the conductive principle, and a sound transducer (130) that is designed to emit sound waves into the fluid (12) in such a way that the sound waves are reflected back to the sound transducer (130) at the first electrode (112) and/or second electrode (114), and to receive the sound waves reflected back to the sound transducer (130) at least at the first electrode (112) and/or second electrode (114) in order to determine the speed of sound in the fluid (12).

In some embodiments, the first electrode (112) and/or second electrode (114) is essentially cylindrical at least in sections.

In some embodiments, the first electrode (112) and/or second electrode (114), at least in sections, has a flat reflection surface (118) that is designed to at least partially reflect the sound waves emitted by the sound transducer (130) back to the sound transducer (130).

In some embodiments, the first electrode (112) is arranged at a predetermined first distance (111) from the sound transducer (130) and the second electrode (114) is arranged at a predetermined second distance (113), different from the first distance (111), from the sound transducer (130).

In some embodiments, there is a further pair of electrodes (120) that has a third electrode (122) and a fourth electrode (124) electrically isolated from the third electrode (122), each of which is in direct contact with the fluid (12), and is designed to determine the electrical conductivity of the fluid (12) in accordance with the conductive principle.

In some embodiments, the third electrode (122) and/or fourth electrode (124) are arranged in an acoustic shadow generated by the first electrode (112) and/or second electrode (114) in such a way that the sound waves emitted by the sound transducer (130) are not reflected back to the sound transducer (130) at the third electrode (122) and/or fourth electrode (124).

In some embodiments, the third electrode (122) and/or fourth electrode (124) have dimensions extending perpendicular to the direction of sound wave propagation that are each smaller than the corresponding dimensions of the first electrode (112) and/or second electrode (114).

In some embodiments, there is a deflection element (140) that is designed to at least partially deflect the sound waves emitted by the sound transducer (130) in the direction of the fluid surface (14) in order to determine the fill level of the fluid (12) in the fluid container (10), from which the sound waves are reflected back to the sound transducer (130) again via the deflection element (140).

In some embodiments, the sound transducer (130) is furthermore designed to be arranged at least partially outside the fluid container (10).

### BRIEF DESCRIPTION OF THE DRAWINGS

Further advantages, features, and embodiments of various teachings of the present disclosure will become apparent to those skilled in the art by implementing the teaching described herein and viewing the accompanying drawings, in which:

FIG. 1 shows a schematic plan view of one embodiment of a sensor device incorporating teachings of the present disclosure in a fluid container;

FIG. 2 shows a schematic plan view of a further embodiment of a sensor device incorporating teachings of the present disclosure in a fluid container;

FIG. 3 shows a schematic plan view of another embodiment of a sensor device incorporating teachings of the present disclosure in a fluid container;

FIG. 4 shows a cross-sectional view of one embodiment of an electrode of a sensor device incorporating teachings of the present disclosure;

FIG. 5 shows a cross-sectional view of a further embodiment of an electrode of a sensor device incorporating teachings of the present disclosure;

FIG. 6 shows a cross-sectional view of another embodiment of an electrode of a sensor device incorporating teachings of the present disclosure;

FIG. 7 shows a schematic plan view of another embodiment of a sensor device incorporating teachings of the present disclosure in a fluid container; and

FIG. 8 shows a side view of the sensor device from FIG. 7.

### DETAILED DESCRIPTION

The teachings of the present disclosure include combining a conductivity sensor with a speed of sound sensor in such a way that the electrodes of the conductivity sensor serve both as electrical elements for recording the electrical conductivity and as reference or reflection elements for the sound waves emitted by the sound transducer of the speed of sound sensor. Thus, in comparison with a mere combination of a conductivity sensor and a speed of sound sensor, a separate reference or reflection element of the speed of sound sensor may be dispensed with, which may lead to a simplified structure and savings in terms of required installation space, costs and weight.

In some embodiments, there is a sensor device for determining electrical conductivity of a fluid and the speed of sound in the fluid, which sensor device has at least one pair of electrodes, which has a first electrode and a second electrode electrically isolated from the first electrode, each of which is in direct contact with the fluid, and is designed to determine the electrical conductivity of the fluid in accordance with the conductive principle, and a sound transducer that is designed to emit sound waves into the fluid in such a way that the sound waves are reflected back to the sound transducer at the first electrode and/or second electrode, and to receive the sound waves reflected back to the sound transducer at least at the first electrode and/or second electrode in order to determine the speed of sound in the fluid.

At least one of the electrodes of the pair of electrodes thus serves firstly as an electrically operating element in order to determine the electrical conductivity of the fluid and secondly as a reference or reflection element for the sound transducer in order to determine the speed of sound in the fluid. Recording the electrical conductivity and the speed of sound in the fluid may provide different, complementary information about the quality and/or the composition of the fluid.

In some embodiments, the first electrode and/or the second electrode are essentially cylindrical and/or rod-shaped, at least in sections. The cross-sectional shape for the sectional cylindrical area of the first electrode and/or of the second electrode may in this case be designed to be circular, elliptical, oval, rectangular, square or any other polygonal shape.

In some embodiments, the first electrode and/or the second electrode have a flat reflection surface that is designed to at least partially reflect the sound waves emitted by the sound transducer back to the sound transducer. This flat reflection surface may in particular increase the proportion of the sound waves emitted by the sound transducer that is reflected back to the sound transducer in such a way that the speed of sound in the fluid is able to be determined as reliably as possible even under unfavorable conditions.

In some embodiments, the first electrode is arranged at a predetermined first distance from the sound transducer and the second electrode is arranged at a predetermined second distance, different from the first distance, from the sound transducer. In some embodiments, the sound waves emitted by the sound transducer reflect at both the first electrode and the second electrode and are received again by the sound transducer, such that the speed of sound of the sound waves in the fluid is determined based on a time-of-flight difference between the sound waves reflected at the first electrode and the sound waves reflected at the second electrode. Only the speed of sound in the fluid is thereby included in the measurement of the speed of sound. This means that any layers located between the sound transducer and the fluid, which may be necessary when the sound transducer is arranged at least partially outside the container, cannot have any influence on the measurement.

In some embodiments, thereis a further pair of electrodes that has a third electrode and a fourth electrode electrically isolated from the third electrode, each of which is in direct contact with the fluid, and is designed to determine the electrical conductivity of the fluid in accordance with the conductive principle. In some embodiments, the sensor device has a four-electrode measurement cell, the two electrodes of the first pair of electrodes of which are operated as what are known as current electrodes and the two electrodes of the further pair of electrodes of which are operated as what are known as voltage electrodes.

In some embodiments, the third electrode and/or fourth electrode are arranged in an acoustic shadow generated by the first electrode and/or second electrode in such a way that the sound waves emitted by the sound transducer are not reflected back to the sound transducer at the third electrode and/or fourth electrode. The sound waves emitted by the sound transducer are thereby able to be reflected back to the sound transducer only at the first electrode and/or second electrode, and specifically not at the third electrode and/or fourth electrode. This makes it possible to at least partially prevent the determination of the speed of sound from being made more difficult or disturbed by the superposition of a plurality of sound reflections.

In some embodiments, the third electrode and/or fourth electrode have dimensions extending perpendicular to the direction of sound wave propagation that are each smaller than the dimension of the first electrode and/or second electrode extending perpendicular to the direction of sound wave propagation, without restricting their functionality for the electrical measurement. It is thereby possible to achieve a situation whereby the acoustic shadow generated by the first electrode and/or second electrode is large enough to avoid the sound waves also being able to be reflected at the third electrode and/or fourth electrode. It should be noted at this juncture that the cross-sectional shapes of the first electrode, second electrode, third electrode and fourth electrode do not have to be identical and may therefore be different.

In some embodiments, the sensor device furthermore has a deflection element that is designed to at least partially deflect the sound waves emitted by the sound transducer in the direction of the fluid surface in order to determine the fluid level, from which the sound waves are reflected back to the sound transducer again via the deflection element. The sensor device may thus also be operated so as to determine the fill level of the fluid in the fluid container, wherein the determination of the fill level of the fluid in the fluid container may be based at least partially on the determined speed of sound in the fluid.

In some embodiments, the sound transducer is furthermore designed to be arranged at least partially outside the fluid container. In such an embodiment, the sound transducer is installed for example on the bottom or on a side wall of the fluid container from the outside, wherein the sound waves then first of all pass through the fluid container wall and are only then coupled into the fluid.

Elements having the same design or function are denoted by the same reference signs throughout the figures. For reasons of clarity, it may be the case that not all elements are identified by reference signs in all of the figures illustrated.

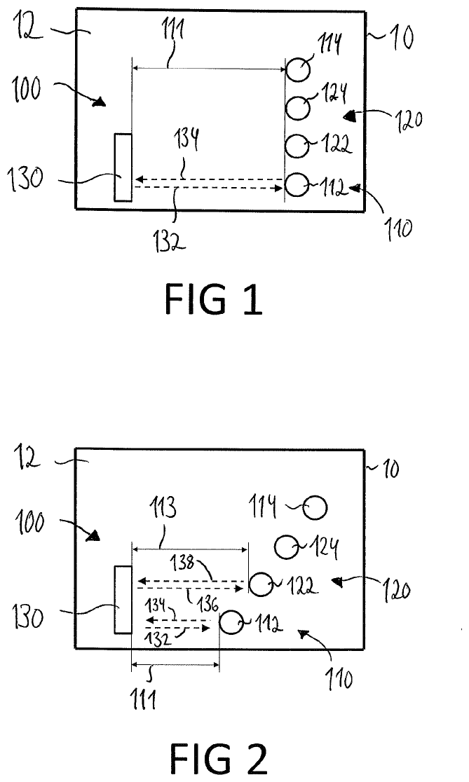

FIG. 1 shows a schematic plan view of one embodiment of a sensor device 100 that is arranged in a fluid container 10. The fluid container 10 contains the fluid 12 to be measured, which may be for example a fluid used in the automotive sector, such as for example water for water injection, a coolant for a coolant circuit of an internal combustion engine of a vehicle, a washing water mixture for cleaning windows, headlights or optical sensors of a vehicle or else other fluids whose state and/or composition are of interest for the operation of the internal combustion engine.

The sensor device 100 is designed to determine the electrical conductivity of the fluid 12 and the speed of sound in the fluid 12. To this end, the sensor device 100 has at least one pair of electrodes 110 that has a first electrode 112 and a second electrode 114 electrically isolated from the first electrode 112, each of which are essentially rod-shaped electrodes. Both the first electrode 112 and the second electrode 114 are each in direct contact with the fluid. The pair of electrodes 110 is designed to determine the electrical conductivity of the fluid in accordance with the conductive principle. To this end, a predetermined voltage is in particular applied to the electrodes 112, 114 of the pair of electrodes 110 and the electric current resulting from this applied voltage between the first electrode 112 and the second electrode 114 is measured as a measure of the electrical conductivity.

The first electrode 112 and the second electrode 114 are in this case each arranged at a predetermined first distance 111 from a sound transducer 130, which is designed to emit sound waves into the fluid in such a way that the sound waves are reflected back to the sound transducer 130 at least at the first electrode 112 and to receive the sound waves reflected at least at the first electrode 112 in order to determine the speed of sound in the fluid 12. The direction of propagation of the sound waves emitted by the sound transducer 130 is indicated by the arrow 132 in FIG. 1, and the direction of propagation of the sound waves reflected back to the sound transducer 130 at the first electrode 112 is indicated by the arrow 134 in FIG. 1.

The sound waves emitted by the sound transducer 130 may be ultrasound waves with a frequency of between approximately 20 kHz and approximately 10 MHz.

In the exemplary embodiment illustrated in FIG. 1, the sound transducer 130 is arranged inside the fluid container 10. In alternative embodiments of the sensor device according to the invention, the sound transducer 130 may be outside the fluid container 10, wherein, in such an embodiment, the sound waves emitted by the sound transducer 130 first of all pass through the wall of the fluid container 10 and are then coupled into the fluid 12.

FIG. 1 furthermore illustrates a further pair of electrodes 120 including a third electrode 122 and a fourth electrode 124 electrically isolated from the third electrode 122, each of which is in direct contact with the fluid 12. The further pair of electrodes 120 is likewise designed to determine the electrical conductivity of the fluid in accordance with the conductive principle. The further pair of electrodes 120 in particular serves to minimize interfering influences due to polarization effects or depositions on the electrodes through a current-free measurement of the potential difference, and thus also to minimize aging phenomena of the sensor.

The third electrode 122 and the fourth electrode 124 may be arranged in an electrical potential field between the first electrode 112 and the second electrode 114 and are likewise at the predetermined first distance 111 from the sound transducer 130.

The predetermined first distance 111 is in particular the distance between the sound transducer 130 and the pairs of electrodes 110, 120 in the direction of propagation 132 of the sound waves emitted by the sound transducer 130.

In the sensor device 100 of FIG. 1, the first electrode 112 has a dual function, specifically that of determining the electrical conductivity of the fluid 12 and that of constituting a reference or reflection element for the sound transducer 130 in order to determine the speed of sound in the fluid 12. It is thus possible with the sensor device 100 to save on a separate reference or reflection element, which may lead to a reduction in the required installation space, the costs and the weight of the overall sensor device 100.

FIG. 2 shows a further example embodiment of the sensor device 100. The embodiment of the sensor device 100 of FIG. 2 differs from the sensor device 100 of FIG. 1 in that each of the four electrodes 112, 114, 122, 124 of the two pairs of electrodes 110, 120 are arranged at a different distance from the sound transducer 130 and that the sound transducer 130 is furthermore designed to emit sound waves into the fluid 12 in such a way that they are reflected back to the sound transducer 130 at at least two electrodes arranged at different distances from the sound transducer 130.

In the exemplary embodiment of FIG. 2, the sound waves are reflected at the first electrode 112, which is arranged at the predetermined first distance 111 from the sound transducer 130, and at the third electrode 122, which is arranged at a predetermined second distance 113 from the sound transducer 130. The direction of propagation of the sound waves emitted to the third electrode 122 is identified by the arrow 136 in FIG. 2, and the direction of propagation of the sound waves reflected back to the sound transducer 130 at the third electrode 122 is identified by the arrow 138 in FIG. 2. As an alternative, the sound waves may be reflected at another two electrodes, such as for example at the first electrode 112 and at the second electrode 114.

Due to the different predetermined distances 112, 113, it is possible to determine the speed of sound in the fluid 12 based on a time-of-flight difference between the sound waves reflected at the first electrode 112 and at the third electrode 122. This measurement principle may in turn compensate for interfering influences, such as for example the times of flight through the wall of the fluid container 10, when the sound transducer 130 is installed at least partially outside the container 10.

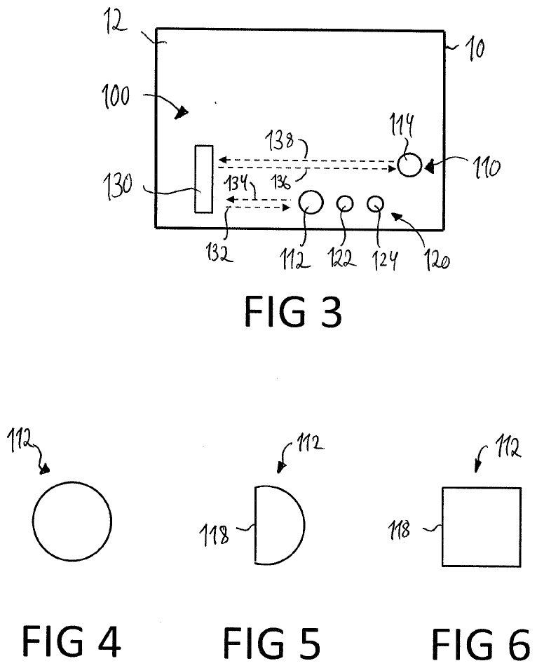

FIG. 3 shows another embodiment of the sensor device 100, which again differs from the sensor devices 100 shown in FIGS. 1 and 2 in terms of the arrangement of the electrodes 112, 114, 122, 124. In the embodiment of FIG. 3, the first electrode 112 is again arranged at the predetermined first distance 111 from the sound transducer 130 and the second electrode 114 is again arranged at the predetermined second distance 113. The third electrode 122 and the fourth electrode 124 of the further pair of electrodes 120 are in this case arranged in an acoustic shadow of the first electrode 112. In some embodiments, the third electrode 122 and/or the fourth electrode 124 may be arranged in the acoustic shadow of the second electrode 114.

This makes it possible to at least partially prevent further sound reflections from taking place at the third electrode 122 and/or the fourth electrode 124, which may distort the intended sound reflections and impair the determination of the speed of sound. The acoustic shadow in this case denotes that area behind the first electrode 112 into which no sound waves pass directly from the sound transducer 130. The third electrode 122 and/or fourth electrode 124 may have dimensions extending perpendicular to the direction of sound wave propagation that are each smaller than the corresponding dimensions of the first electrode 112 and/or second electrode 114.

In the embodiment of FIG. 3, the third electrode 122 and the fourth electrode 124 of the further pair of electrodes 120 to furthermore be located essentially in the electrical field that is generated by applying a voltage to the first electrode 112 and the second electrode 114 of the first pair of electrodes 110.

FIG. 4 to FIG. 6 each show different designs for the cross-sectional shape of the first electrode 112. It goes without saying that the second electrode 114, the third electrode 123 and the fourth electrode 124 may also each have the cross-sectional shapes illustrated in FIG. 4 to FIG. 6. It should also be noted at this juncture that, in one embodiment of the sensor device 100, the cross-sectional shapes of all of the electrodes 112, 114, 122, 124 do not have to be identical. That is to say that, in one embodiment, the electrodes 112, 114, 122, 124 may each have different cross-sectional shapes.

FIG. 4 shows a circular cross-sectional shape of the first electrode 112, which has an essentially cylindrical design. The diameter may vary in this case.

FIG. 5 illustrates a flattened circular cross-sectional shape of the first electrode 112. The cross-sectional shape in FIG. 5 results in particular from the fact that the circular cross section in FIG. 4 is trimmed such that a substantially flat reflection surface 118 is formed. The essentially flat reflection surface 118 is designed in particular to reflect the sound waves impinging thereon back to the sound transducer 130 again. The larger the flat reflection surface 118, the greater the proportion of the sound waves emitted by the sound transducer 130 that is reflected back to the sound transducer 130.

In some embodiments, the essentially cylindrical electrode 112 may have a predominantly circular cross section, but the cross-sectional shape shown in FIG. 5 in sections at a suitable point so that the essentially flat reflection surface 118 is arranged at this suitable point.

FIG. 6 shows an essentially square cross-sectional shape of the first electrode 112. In some embodiments, any rectangular cross-sectional shape or any other cross-sectional shape known from the prior art for electrodes may be used.

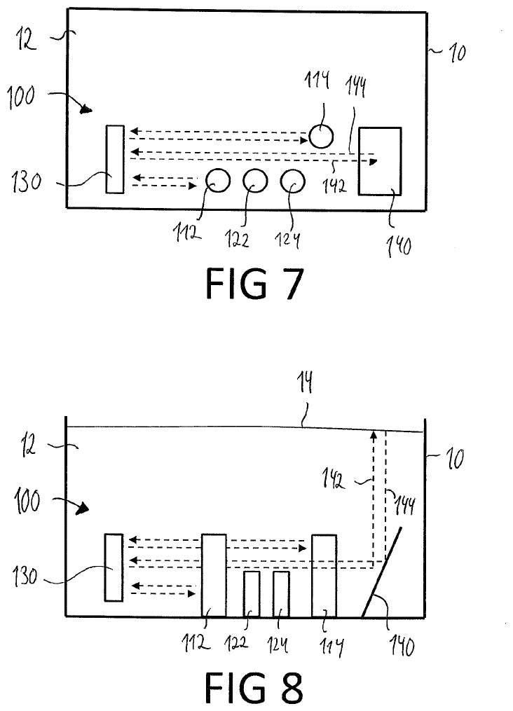

FIGS. 7 and 8 show a further embodiment that differs from the sensor device 100 of FIG. 3 in that the sensor device 100 of FIGS. 7 and 8 furthermore has a deflection element 140 that is arranged in the fluid 12 inside the fluid container 10. The deflection element 140 is designed in particular to deflect sound waves emitted by the sound transducer 130 in the direction of the fluid surface 14 in such a way that the sound waves are able to be reflected at the fluid surface 14 and are able to be reflected back to the sound transducer 130 again via the deflection element 140. The sound path of these sound waves is indicated by the arrows 142 and 144 in FIGS. 7 and 8. By virtue of the deflection element 140, it is possible, in addition to the speed of sound in the fluid 12, also to determine the fill level 14 of the fluid inside the fluid container 10 based on the determined speed of sound in the fluid 12.

What is claimed is:

1. A sensor device for determining an electrical conductivity of a fluid and a speed of sound in the fluid, the sensor device comprising:
a first electrode;
a second electrode electrically isolated from the first electrode;
wherein each electrode is in direct contact with the fluid, and is operable to determine the electrical conductivity of the fluid using the conductive principle; and
a sound transducer to emit sound waves into the fluid toward the first electrode and/or the second electrode, and to receive sound waves reflected back by the respective electrode to determine the speed of sound in the fluid.

2. The sensor device as claimed in claim 1, wherein at least one of the first electrode and the second electrode is cylindrical at least in sections.

3. The sensor device as claimed in claim 1, wherein at least one of the first electrode and/or the second electrode, at least in sections, has a flat reflection surface.

4. The sensor device as claimed in claim 1, wherein:
the first electrode is arranged at a predetermined first distance from the sound transducer; and
the second electrode is arranged at a predetermined second distance, different from the first distance, from the sound transducer.

5. The sensor device as claimed in claim 1, further comprising:
a second pair of electrodes including a third electrode and a fourth electrode electrically isolated from one another;
wherein the second pair of electrodes are each in direct contact with the fluid, and each operable to determine the electrical conductivity of the fluid using the conductive principle.

6. The sensor device as claimed in claim 5, wherein the third electrode is arranged in an acoustic shadow generated by the first electrode and/or the second electrode so the sound waves emitted by the sound transducer are not reflected back to the sound transducer at the third electrode.

7. The sensor device as claimed in claim 5, wherein the third electrode has a dimension extending perpendicular to a direction of sound wave propagation smaller than the corresponding dimensions of the first electrode and/or the second electrode).

8. The sensor device as claimed in claim 1, further comprising a deflection element to at least partially deflect the sound waves emitted by the sound transducer toward a fluid surface to determine a fill level of the fluid in the fluid container;
wherein the deflection element reflects the sound waves back to the sound transducer from the surface of the fluid.

9. The sensor device as claimed in claim 1, wherein the sound transducer is at least partially outside the fluid container.
